(19) United States
(12) Patent Application Publication
(10) Pub. No.: US 2026/0073191 A1
(43) Pub. Date: Mar. 12, 2026

(54) TEC MAP PREDICTION SYSTEM AND METHOD USING DEEP LEARNING

(71) Applicant: KOREA ASTRONOMY AND SPACE SCIENCE INSTITUTE, Daejeon (KR)

(72) Inventors: Se-Heon JEONG, Daejeon (KR); Woo Kyoung LEE, Daejeon (KR); Byung-Kyu CHOI, Daejeon (KR); Jeong-Heon KIM, Daejeon (KR)

(21) Appl. No.: 19/383,044

(22) Filed: Nov. 7, 2025

(30) Foreign Application Priority Data
Sep. 10, 2024 (KR) 10-2024-0123304

(51) Int. Cl. G06N 3/0464; G06N 3/045; G06N 3/0475; G06N 3/08

(52) U.S. Cl. CPC G06N 3/0464; G06N 3/045; G06N 3/0475; G06N 3/08

(57) ABSTRACT

The present disclosure relates to a TEC map prediction system and method using deep learning. The present disclosure relates to a technique for predicting two-dimensional TEC maps using a deep learning model, and more particularly, to a technology capable of more accurately restoring/predicting regional TEC maps with a small-scale structure to provide a precise TEC map.

### CROSS-REFERENCE TO RELATED APPLICATIONS

This application claims priority under 35 U.S.C. § 119 to Korean Patent Application No. 10-2024-0123304, filed on Sep. 10, 2024, in the Korean Intellectual Property Office, the disclosure of which is incorporated herein by reference in its entirety.

### TECHNICAL FIELD

The following disclosure relates to a total electron content (TEC) map prediction system and method using deep learning, and more particularly, to a TEC map prediction system and method using deep learning capable of restoring a TEC map, which is an important indicator indicating an electron density of the Earth's ionosphere, but frequently has data missing in some areas s due to geographical limitations of GNSS receivers, device failures, and data transmission errors.

In addition, the present disclosure relates to a TEC map prediction system and method using deep learning capable of predicting and providing a future TEC map based on the reconstructed TEC map.

### BACKGROUND

The Earth's ionosphere constitutes a region in the upper atmosphere where a region containing a high concentration of charged particles. This region plays a crucial role in various technological and scientific applications, such as radio communications and navigation. The behavior of the ionosphere is influenced by various factors, including solar and geomagnetic activity, natural phenomena on the Earth's surface (e.g., earthquakes, tropical storms, volcanic eruptions, etc.), and anthropogenic events (e.g., rocket launches and explosions, etc.). One key parameter representing the ionosphere is the total electron (TEC) content estimated from global navigation (GNSS) data. The accurate prediction of the TEC values is very crucial because it significantly affects the phase, amplitude, and delay of GNSS signals.

Since the GNSS-derived TEC also provides a key resource for ionospheric research, the importance of the TEC continues to grow for both practical and scientific purposes. Accordingly, significant efforts are being made worldwide to acquire high-spatial and temporal resolution TEC data.

As a result, various TEC prediction methods have been proposed. These methods may be broadly divided into empirical models and physics models. The empirical models use statistics and regression analysis to predict TEC based on long-term TEC data and other input values such as solar and geomagnetic activity data. While these empirical models are simple and computationally efficient, they struggle to capture the high-level spatial and temporal variability of the ionosphere. The physics models predict the TEC values by numerically simulating physical and chemical processes in the ionosphere. Such models are more complex and computationally intensive than the empirical models, and have a problem in that numerical simulations may not capture all the complexities of the ionosphere, although and have the advantage of being able to trace the roles of various processes involved in ionospheric variations.

An example of such physics models is the Whole Atmosphere Model-Ionosphere Plasmasphere Electrodynamics (WAM-IPE) operated by the U.S. National Oceanic and Atmospheric Administration's Space Weather Prediction Center. These models ground-based utilize and space-based observations, solar activity indices, geomagnetic data, and lower atmospheric forcing to characterize and predict the ionosphere, but still pose challenges in terms of the complexity and computational time required for their operation.

With the recent emergence of various deep learning techniques, their application to the TEC prediction has also been proposed. These studies demonstrate that deep learning methods are well-suited for handling the complex and nonlinear characteristics of the ionosphere. To design these deep learning models, a variety of TEC values at different locations are essential. However, generating the TEC values at various locations is time-consuming, and creating a complete TEC map including filling in gaps caused by the geographical limitations, etc., of the GNSS receivers requires additional effort.

Specifically, since GNSS observation data from certain regions may be missing due to various reasons, such as the geographic limitations of the GNSS receivers, the device failures, or the data transmission errors, the TEC maps are typically in a state with missing parts (gaps).

This missing data poses a significant challenge during the training process of the deep learning model. That is, incomplete training due to missing data may lead to overfitting or underfitting, degrading model performance, which naturally has a negative impact on the prediction accuracy.

Consequently, although various deep learning techniques have been applied to the TEC prediction, enabling more accurate and reliable predictions, the inherent lack of observation data, i.e., the training data itself makes it difficult to create predictive models that provide reliable predictions.

In this regard, Korean Patent No. 10-2562273 (“Apparatus for forecasting 24-hour global total electron content using deep learning based on conditional generative adversarial neural network and method thereof”) discloses a device that uses a current total electron content image to predict the total electron content image 24 hours later.

### SUMMARY

An embodiment of the present disclosure is directed to providing a total electron content (TEC) map prediction system and method using deep learning which can serve as an important parameter for studying the Earth's ionosphere and space weather by restoring a TEC map, which is an important indicator indicating an electron density of the Earth's ionosphere, but frequently has data missing in some areas due to geographical limitations of GNSS receivers, device failures, and data transmission errors. This system is capable of predicting and providing a future TEC map based on the reconstructed TEC map.

In one general aspect, a TEC map prediction system using deep learning includes: a data input unit that receives externally observed TEC map image data; a first model processing unit that inputs the observed TEC map image data to a stored first artificial intelligence model and receives reconstructed synthetic TEC map; a synthesis processing unit that synthesizes the observed TEC map image data received and the reconstructed synthetic TEC map using a pre-stored image processing algorithm to generate optimized TEC map image data; and a second model processing unit that inputs the optimized TEC map image data to a stored second artificial intelligence model and receives predicted TEC map image data at predetermined time intervals from a predetermined point in time based on when the optimized TEC map image data is input.

The TEC map prediction system using deep learning may further include: a generation unit that is implemented as a convolutional neural network, and receives a random vector for a latent space and arbitrary TEC map condition information to generate corresponding synthetic TEC map; a ground truth input unit that receives TEC map image data generated ionospheric parameters as input to a linked empirical model; a discrimination unit that is implemented as a convolutional neural network, and receives the TEC map image data generated by the ground truth input unit and the synthetic TEC map generated by the generation unit to discriminate whether the input data is the received TEC map image data or the generated TEC map image data; a measurement input unit that receives the observed TEC map image data corresponding to the TEC map image data generated by the ground truth input unit from the outside; and an optimization processing unit that optimizes the neural network of the generation unit using the pre-stored optimization algorithm so that a difference between the synthetic TEC map generated by the generation unit and the observed TEC map image data corresponding to the synthetic TEC map is minimized, in which the generation unit and the discrimination unit may be trained based on a deep convolution generative adversarial network (DCGAN), and the neural network of the generation unit optimized by the optimization processing unit may be stored as the first artificial intelligence model.

The TEC map prediction system using deep learning may further include: a data collection unit that inputs an observed TEC map image dataset at predetermined time intervals for a predetermined time to the neural network of the generation unit optimized by the optimization processing unit, and receives a synthetic TEC maps; a set generation unit that synthesizes each synthetic TEC map and the corresponding observed TEC map image data using the pre-stored image processing algorithm to generate an optimized TEC map image dataset; and a learning processing unit that performs learning process using the optimized TEC map image dataset based on a convolutional long short-term memory (ConvLSTM) model, in which the model generated by the learning processing unit may be stored as the second artificial intelligence model.

In another general aspect, a TEC map prediction method using deep learning by a TEC map prediction system using deep learning in which each step is performed by a computational processing unit includes: a data input step (S100) of receiving, by a data input unit, externally observed TEC map image data; a first model processing step (S200) of inputting, by a first model processing unit, the observed TEC map image data received in the data input step (S100) to a stored first artificial intelligence model, and receiving reconstructed synthetic TEC map; a synthesis processing step (S300) of using, by a synthesis processing unit, a pre-stored image processing algorithm to synthesize the observed TEC map image data received in the data input step (S100) and synthetic TEC map reconstructed in the first model processing step (S200) to generate optimized TEC map image data; and a second model processing step (S400) of inputting, by a second model processing unit, the optimized TEC map image data to a stored second artificial intelligence model in the synthesis processing step (S300) and receiving predicted TEC map image data at predetermined time intervals from a predetermined point in time based on when the optimized TEC map image data is input.

The TEC map prediction method using deep learning may further include: prior to performing the first model processing step (S200), a generation step (S10) of receiving, by a generation unit implemented as a convolutional neural network, a random vector for a latent space and arbitrary TEC map condition information to generate the corresponding synthetic TEC map; a ground truth input step (S20) of receiving, by a ground truth input unit, TEC map image data generated using the TEC map condition information through a linked empirical model; a discrimination step (S30) of receiving, by a discrimination unit implemented as the convolutional neural network, the TEC map image data generated by the ground truth input step (S20) and the synthetic TEC map generated by the generation step (S10) to discriminate whether the input data is the received TEC map image data or the generated TEC map image data; a measurement input step (S40) of receiving, by a measurement input unit, the observed TEC map image data corresponding to the TEC map image data generated by the ground truth input step (S20) from the outside; and an optimization processing step (S50) of optimizing, by an optimization processing unit, the neural network generated by the generation step (S10) using a pre-stored optimization algorithm so that a difference between the synthetic TEC map generated by the generation step (S10) and the observed TEC map image data corresponding to the synthetic TEC map is minimized, in which the generation step (S10) and the discrimination step (S30) may be trained based on a deep convolution generative adversarial network (DCGAN), and the neural network optimized by the optimization processing step (S50) may be stored as the first artificial intelligence model.

The TEC map prediction method using deep learning may further include: prior to performing the second model processing step (S400), a data collection step (S60) of inputting, by a data collection unit, an observed TEC map image dataset at predetermined time intervals for a predetermined time to the neural network optimized by the optimization processing step (S50), and receiving a synthetic TEC map; a set generation step (S70) of synthesizing, by a set generation unit, each synthetic TEC map received by the data collection step (S60) and the corresponding observed TEC map image data using the pre-stored image processing algorithm to generate an optimized TEC map image dataset; and a learning processing step (S80) of performing, by a learning processing unit, learning process using the optimized TEC map image dataset by the set generation step (S70) based on a convolutional long short-term memory (ConvLSTM) model, in which the model generated by the learning processing step (S80) may be stored as the second artificial intelligence model.

### BRIEF DESCRIPTION OF THE DRAWINGS

FIG. 1 is an exemplary diagram illustrating a configuration of a TEC map prediction system using deep learning according to an embodiment of the present disclosure.

FIGS. 2 and 3 are an exemplary diagram comparing observed TEC map image data and optimized TEC map image data in a TEC map prediction system and method using deep learning according to an embodiment of the present disclosure.

FIG. 4 is an exemplary diagram illustrating a process for generating the optimized TEC map image data in the TEC map prediction system and method using deep learning according to an embodiment of the present disclosure.

FIG. 5 is an exemplary diagram illustrating TEC map gap-filling results using a TEC map prediction system and method using deep learning according to an embodiment of the present disclosure.

FIG. 6 is a performance evaluation result for prediction results using the TEC map prediction system and method using deep learning according to an embodiment of the present disclosure.

FIG. 7 is an exemplary flowchart illustrating the TEC map prediction method using deep learning according to an embodiment of the present disclosure.

### DETAILED DESCRIPTION OF MAIN ELEMENTS

100: Data input unit
200: First model processing unit
300: Synthesis processing unit
400: Second model processing unit
10: Generation unit
20: Ground truth input unit
30: Discrimination unit
40: Measurement input unit
50: Optimization processing unit
60: Data collection unit
70: Set generation unit
80: Learning processing unit

### DETAILED DESCRIPTION OF EMBODIMENTS

Hereinafter, a TEC map prediction system and method using deep learning according to the present disclosure having the above-described configuration will be described in detail with reference to the accompanying drawings. The drawings to be provided below are provided by way of example so that the spirit of the present disclosure can be sufficiently transferred to those skilled in the art. Therefore, the present disclosure is not limited to the drawings to be provided below, but may be implemented in other forms. In addition, like reference numerals denote like elements throughout the specification.

Technical terms and scientific terms used in the present specification have the general meaning understood by those skilled in the art to which the present disclosure pertains unless otherwise defined, and a description for the known function and configuration unnecessarily obscuring the gist of the present disclosure will be omitted in the following description and the accompanying drawings.

In addition, a system means a set of components including devices, mechanisms, means, and the like, systematized in order to perform required functions and regularly interacting with one another.

Total electron content (TEC) is a key indicator indicating an electron density in the Earth's ionosphere, and is estimated and calculated using global navigation satellite system (GNSS) data. The accurate prediction of the TEC values is very crucial because it significantly affects the phase, amplitude, and delay of GNSS signals. However, due to the geographical limitations of GNSS observatories, GNSS observation data is unavailable in areas such as oceans, resulting in missing TEC map image data.

Recently, even if widely known deep learning techniques are used to predict TEC maps, training data itself is missing, resulting in low prediction accuracy and reliability.

To address this issue, a TEC map prediction system and method using deep learning according to an embodiment of the present disclosure relates to a technology that utilizes deep learning and image processing techniques to reconstruct missing regions in observed TEC maps, thereby generating completely optimized TEC map image data.

In addition, it goes beyond simply generating optimized TEC map image data, and it may predict and provide variations in TEC map image data for up to the next 24 hours based on the optimized TEC map image data generated using deep learning techniques.

In short, the TEC map prediction system and method using deep learning according to an embodiment of the present disclosure utilizes deep convolutional generative adversarial network-Poisson blending (DCGAN-PB) to generate optimized TEC map image data, and utilizes the convolutional long-short term memory (ConvLSTM) technique to predict and provide the TEC map image data for up to the next 24 hours based on the optimized TEC map image data.

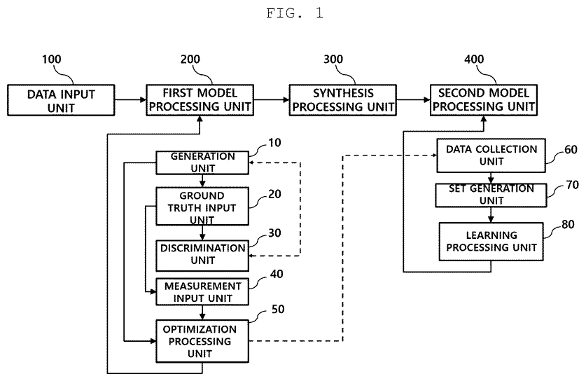

FIG. 1 is an exemplary diagram illustrating a configuration of a TEC map prediction system using deep learning according to an embodiment of the present disclosure. As illustrated in FIG. 1, the TEC map prediction system using deep learning according to an embodiment of the present disclosure preferably includes a data input unit 100, a first model processing unit 200, a synthesis processing unit 300, and a second model processing unit 400.

Each of these components is preferably integrated into multiple computational processing units, including a CPU, or a single computational processing unit, to perform operations.

Detailing each component, the data input unit 100 preferably receives observed total electron content (TEC) map image data in the form of image data from the outside.

Here, the “outside” refers to a connected external computational unit, and the observed TEC map image data refers to the TEC map image data estimated using GNSS data.

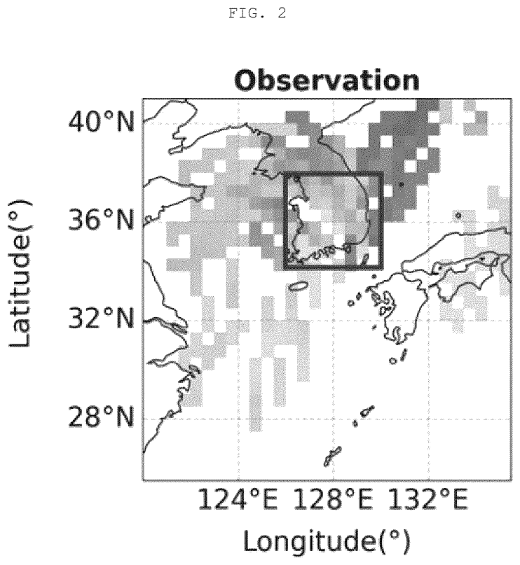

As illustrated in FIG. 2, the TEC map image data estimated using the GNSS data is missing data in areas with geographical limitations of GNSS observatories, such as the ocean.

The first model processing unit 200 preferably inputs the observed TEC map image data obtained by the data input unit 100 to the stored first artificial intelligence model, thereby outputting reconstructed synthetic TEC map.

It can be seen that the synthetic TEC map is TEC map image data in a complete form with all observational gaps filled.

The TEC map prediction system using deep learning according to an embodiment of the present disclosure preferably further includes a generation unit 10, a ground truth input unit 20, a discrimination unit 30, a measurement input unit 40, and an optimization processing unit 50, as illustrated in FIG. 1, to store the first artificial intelligence model.

Here, the generation unit 10 and the discrimination unit 30 perform learning process based on a deep convolutional generative adversarial network (DCGAN).

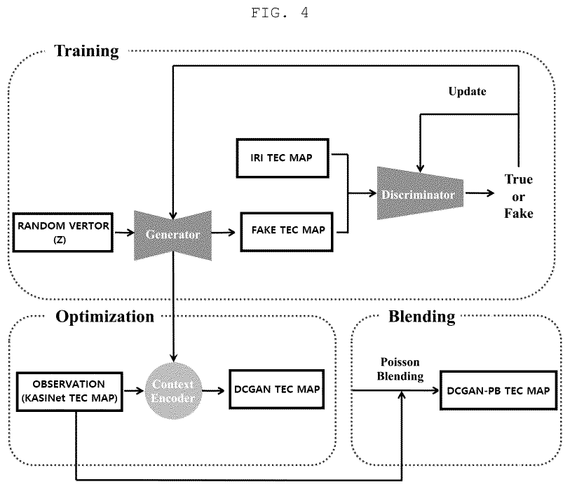

Specifically, as illustrated in FIG. 4, the generation unit 10 is a generator implemented as a convolutional neural network, and collects the TEC map image data based on the International Reference Ionosphere (IRI)-2016 model that is an empirical model widely used in the ionosphere field, and generates the TEC map image data as training data to allow the generator to perform learning to generate the synthetic TEC map. Thereafter, the generator receives a random vector (z) for the latent space and arbitrary TEC map condition information, and generates corresponding synthetic TEC map.

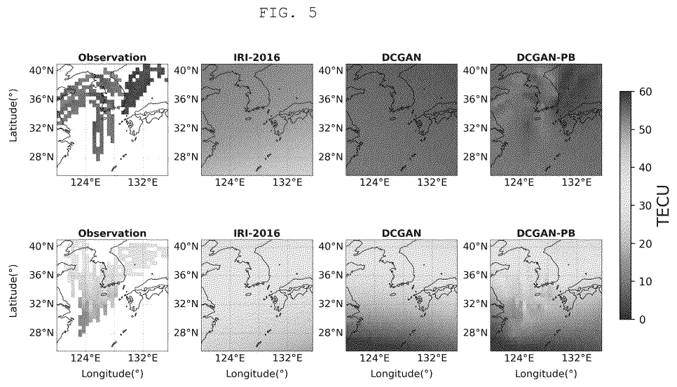

The ground truth input unit 20 preferably receives the TEC map image data generated using the TEC map condition information through the linked empirical model, the IRI-2016 model. As illustrated in FIG. 5, unlike the observed TEC map image data, the TEC map image data generated using the IRI-2016 model is in the form of the complete TEC map image data without missing regions.

As illustrated in FIG. 4, the above-described discrimination unit 30 is a discriminator implemented as a convolutional neural network, and receives the TEC map image data generated by the ground truth input unit 20 and the synthetic TEC map generated by the generation unit 10, and discriminates whether the input data is actual TEC map image data (the TEC map image data generated by the ground truth input unit 20) or synthetic TEC map (the synthetic TEC map generated by the generation unit 10).

In this way, the generator uses the probability density of actual training data (the TEC map image data generated through the empirical model) to generate synthetic data (the synthetic TEC map), and the discriminator receives actual training data and the synthetic data generated by the generator to discriminate whether the input data is actual data or synthetic data. In this case, the generator and discriminator are trained adversarially, so that the synthetic data generated by the generator is trained to generate images similar to real ones.

The training is performed by allowing the generator to generate the synthetic TEC map from the random vector, and the discriminator to discriminate between the synthetic TEC map generated by the generator and the actual TEC map image data (the TEC map image data according to IRI-2016) while reducing the loss between the two images. As the number of epoch increases, the loss decreases, and the generator generates the synthetic TEC map that is very similar to the actual TEC map image data.

The measurement input unit 40 preferably receives the observed TEC map image data corresponding to the TEC map image data generated by the ground truth input unit 30 from the outside.

Here, the “outside” refers to a connected external computational unit, and the observed TEC map image data refers to TEC map image data estimated using GNSS data. As illustrated in FIG. 4, the TEC map image data estimated using the GNSS data is missing data in areas with geographical limitations of GNSS observatories, such as the ocean.

The optimization processing unit 50 preferably optimizes the neural network of the generation unit 10 using the pre-stored optimization algorithm so that the difference between the synthetic TEC map generated by the generation unit 10 and the observed TEC map image data corresponding to the synthetic TEC map is minimized.

Specifically, as described above, the synthetic TEC map generated by the generation unit 10 is generated by receiving the random vector for the latent space and arbitrary TEC map condition information, and the ground truth input unit 20 may receive the TEC map image data generated using the TEC map condition information. In addition, the observed TEC map image data corresponding to the TEC map image data generated by the ground truth input unit 30, in other words, the observed TEC map image data corresponding to the empirical data for generating the TEC map image data by the ground truth input unit 30 may be received through the measurement input unit 40.

The optimization processing unit 50 preferably optimizes the neural network of the generation unit 10 using the observed TEC map image data so that the difference between the synthetic TEC map generated by the generation unit 10 and the observed TEC map image data corresponding to the synthetic TEC map is minimized.

As described above, since the observed TEC map image data includes missing regions, the optimization processing unit 50 may compare values of the measured portions in the observed TEC map image data with the corresponding portions in the output values of the synthetic TEC map to perform optimization for the regions that do not exist in the observed TEC map image data but exist in the synthetic TEC map. Of course, the optimization is also performed to minimize differences between existing regions.

The present disclosure is not limited to the optimization algorithm itself for neural network optimization.

The first model processing unit 200 preferably stores the neural network generated by the generation unit 10, which is optimized by the optimization processing unit 50, as the first artificial intelligence model.

In this way, even when the observed TEC map image data including missing regions is input, the first model processing unit 200 outputs the complete synthetic TEC map without missing regions by reconstructing the observed TEC map image data.

The synthesis processing unit 300 preferably synthesizes the observed TEC map image data input by the data input unit 100 and the synthetic TEC map reconstructed by the first model processing unit 200 using the pre-stored image processing algorithm, thereby generating the optimized TEC map image data.

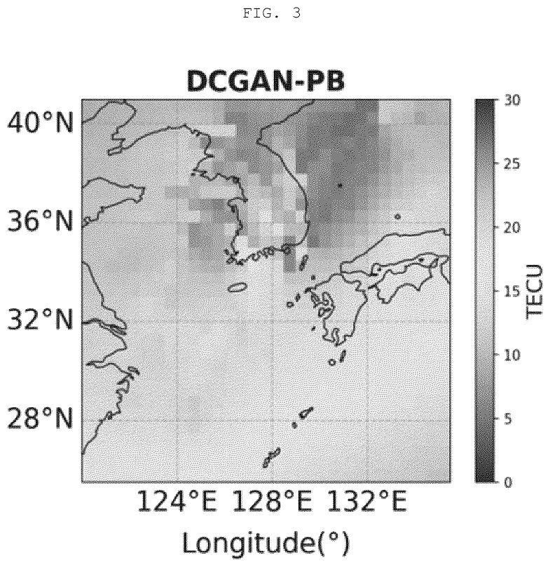

That is, as illustrated in FIG. 4, the synthesis processing unit 300 naturally synthesizes the observed TEC map image data input by the data input unit 100 and the synthetic TEC map reconstructed by the first model processing unit 200, which are two different image data, using the Poisson Blending technique as the pre-stored image processing algorithm, thereby generating the optimized TEC map image data. In this way, the observed ionospheric structure is preserved, and the missing area is filled in with the synthetic TEC map, thereby generating the optimized TEC map image data, as illustrated in FIG. 3.

When simply synthesizing the observed TEC map image data and the synthetic TEC map, there is a problem in that the image itself becomes significantly distorted because pixels corresponding to the missing region of the observed TEC map image data in the synthetic TEC map are mismatched compared to the surrounding pixels. Therefore, a gradient value between the observed TEC map image data input by the data input unit 100 and the synthetic TEC map reconstructed by the first model processing unit 200 is minimized through the synthesis processing unit 300 so that the observed TEC map image data is naturally synchronized with the surrounding pixels, thereby generating the optimized TEC map image data.

In addition, the optimized TEC map image data generated by the synthesis processing unit 300 not only simply compensates for the loss of the observed TEC map image data, but may also accurately reconstruct small-scale structures.

In particular, global TEC maps tend to be easier to learn with deep learning techniques due to their large-scale structural features. However, although local TEC maps include various small-scale structures, the learning process may be more difficult. However, by providing the optimized TEC map image data that accurately reconstructs even small-scale transformations through the first model processing unit 200 and the synthesis processing unit 300, more precise TEC map image data is provided.

FIG. 5 is a diagram illustrating the observed TEC map image data, the TEC map image data generated by the empirical model, and the optimized TEC map image data generated by the synthesis processing unit 300. It may be confirmed that the optimized TEC map image data generated by the synthesis processing unit 300 preserves the ionospheric structure observed in the observed TEC map image data, while the missing regions are filled with the synthetic TEC map.

The present disclosure goes beyond the reconstruction of the complete TEC map image data and aims to predict the TEC map image data in the future using the reconstructed TEC map image data.

To this end, the second model processing unit 400 preferably inputs the optimized TEC map image data obtained by the synthesis processing unit 300 to the stored second artificial intelligence model, thereby outputting the predicted TEC map image data at predetermined time intervals from the point in time at which the observed TEC map image data was input until a predetermined point in time later.

Here, the predetermined point in time means 24 hours, and the predetermined time means 1 hour. The predicted TEC map image data at 1-hour intervals from the point in time of the observed TEC map image data input through the data input unit 100 until 24 hours later is output.

In this case, the predetermined point in time and the predetermined time are not necessarily limited to these. However, although the predetermined point in time and the predetermined time are not necessarily limited to these values, various experimental results of the present disclosure have confirmed that, when limited to 24 hours and 1 hour, the prediction results exhibit the highest reliability and accuracy, and thus these values were adopted.

According to an embodiment of the present disclosure, the TEC map prediction system using deep learning preferably further includes a data collection unit 60, a set generation unit 70, and a learning processing unit 80, as illustrated in FIG. 1, to store the second artificial intelligence model.

The data collection unit 60 inputs the observed TEC map image dataset at predetermined time intervals for a predetermined time to the neural network of the generation unit 10 for which the optimization has been performed by the optimization processing unit 50, thereby outputting the synthetic TEC map.

As described above, since the best prediction result is output when the predetermined point in time is 24 hours and the predetermined time is 1 hour, the data collection unit 60 receives the observed TEC map image data at 1-hour intervals up to 24 hours prior to a certain point in time or the observed TEC map image data at 1-hour intervals up to 24 hours immediately following a certain point in time, and outputs the synthetic TEC map corresponding to each observed TEC map image data, thereby generating the synthetic TEC map.

It is preferable that the set generation unit 70 generates the optimized TEC map image dataset by synthesizing the observed TEC map image data corresponding to each synthetic TEC map using the pre-stored image processing algorithm.

Specifically, the set generation unit 70 uses the Poisson Blending technique as the pre-stored image processing algorithm to naturally synthesize the observed TEC map image data input by the data collection unit 60 and the reconstructed synthetic TEC map, which are two different image data, thereby generating the optimized TEC map image data.

The learning processing unit 80 preferably performs the learning process using the optimized TEC map image dataset based on a convolutional long short-term memory (ConvLSTM) model.

The ConvLSTM model, which is a variant of the LSTM network, integrates convolution operations into the standard LSTM architecture. By combining the memory preservation function of LSTM with the spatial pattern recognition function of the convolutional neural network, it effectively processes sequential data with spatial and temporal structures.

In the present disclosure, for predicting the TEC map image data, the input data is the optimized TEC map image data, which is synthetic TEC map, rather than the observed TEC map image data. As described above, the observed TEC map image data may include the missing regions due to various factors.

Since these missing regions ultimately cause significant problems during the training process of the deep learning model, the present disclosure goes beyond simple data supplementation and provides high-quality data that reflects the characteristics and patterns of the observed data as the training data, thereby ensuring a complete dataset essential for training a deep learning predictive model.

In other words, the complete dataset generated using the optimized TEC map image data allows the predictive model to learn consistent patterns, resulting in a stable training process and ultimately better performance. In particular, models such as ConvLSTM may offer significant advantages in learning spatial and temporal patterns, resulting in improved predictive performance.

The learning processing unit 80 utilizes the ConvLSTM model instead of the LSTM model. From various experimental results, it was found that the prediction results of the LSTM model exhibited discontinuities in the TEC values across different grids, whereas the prediction results of the ConvLSTM model showed continuity in the TEC values even across different grids, demonstrating superior performance.

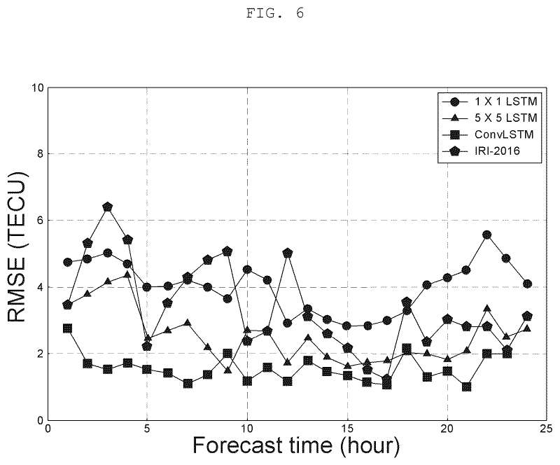

FIG. 6 illustrates the results of calculating an RMSE value between the observed TEC map image data and the predicted TEC map image data corresponding thereto to quantify model-specific based on various experimental results according to the present disclosure. The RMSE value for each grid was calculated and displayed at each prediction time (1 hour) from the reference time. As a result, it may be seen that, on average, the 1×1 LSTM model has the highest RMSE value and the ConvLSTM model has the lowest RMSE value.

It is preferable that the second model processing unit 400 stores the model generated by the learning processing unit 80 as the second artificial intelligence model.

Through this, the second model processing unit 400 outputs the predicted TEC map image data at 1-hour intervals for up to 24 hours based on the input TEC map image data, or simply 24 predicted TEC map image data.

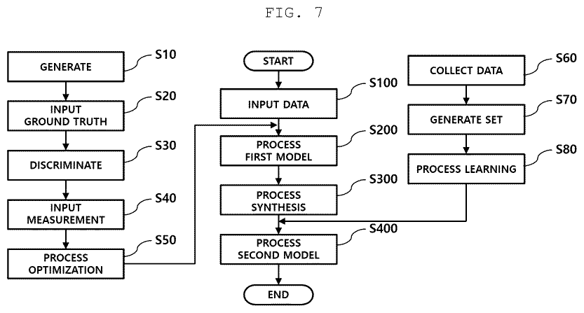

FIG. 7 is an exemplary flowchart illustrating the TEC map prediction method using deep learning according to an embodiment of the present disclosure. As illustrated in FIG. 7, the TEC map prediction method using deep learning according to an embodiment of the present disclosure includes a data input step (S100), a first model processing step (S200), a synthesis processing step (S300), and a second model processing step (S400).

Each step is performed through a TEC map prediction system using deep learning that is individually configured and operated on a plurality of computational processing units including a CPU or integrated into a single computational processing unit.

Detailing each step, in the data input step (S100), the data input unit 100 receives the observed total electron content (TEC) map image data in image data form from the outside. Here, the “outside” refers to a connected external computational unit, and the observed TEC map image data refers to TEC map image data estimated using GNSS data.

As illustrated in FIG. 2, the TEC map image data estimated using the GNSS data is missing data in areas with geographical limitations of GNSS observatories, such as the ocean.

The first model processing step (S200) inputs the observed TEC map image data from the data input step (S100) to the stored first artificial intelligence model in the first model processing unit 200, thereby outputting the reconstructed synthetic TEC map.

It can be seen that the synthetic TEC map is TEC map image data in a complete form with all observational gaps filled.

As illustrated in FIG. 7, prior to performing the first model processing step (S200), the TEC map prediction method using deep learning according to an embodiment of the present disclosure performs a generation step (S10), a ground truth input step (S20), a discrimination step (S30), a measurement input step (S40), and an optimization processing step (S50), thereby storing the first artificial intelligence model.

Here, the generation step (S10) and the discrimination step (S30) are trained based on a deep convolution generative adversarial network (DCGAN).

Specifically, in the generation step (S10), the generation unit 10 implemented as the convolutional neural network, which is the generator, collects the TEC map image data based on the International Reference Ionosphere (IRI)-2016 model that is the empirical model widely used in the ionosphere field, and generates the TEC map image data as the training data to allow the generator to perform learning to generate the synthetic TEC map. Thereafter, the generator receives a random vector (z) for the latent space and arbitrary TEC map condition information, and generates corresponding synthetic TEC map.

In the ground truth input step (S20), the TEC map image data generated using the TEC map condition information through the IRI-2016 model, which is the linked empirical model, is received from the ground truth input unit 20. As illustrated in FIG. 5, unlike the observed TEC map image data, the TEC map image data generated using the IRI-2016 model is in the form of the complete TEC map image data without missing regions.

In the discrimination step (S30), the discrimination unit 30 implemented as the convolutional neural network, which is the discriminator, receives the TEC map image data generated by the ground truth input step (S20) and the synthetic TEC map generated by the generation step (S10), and discriminates whether the received data is actual TEC map image data (the TEC map image data generated by the ground truth input step (S20)) or synthetic TEC map (the synthetic TEC map generated by the generation step (S10)).

In this way, the generator uses the probability density of actual training data (the TEC map image data predicted through the empirical model) to generate synthetic data (the synthetic TEC map), and the discriminator receives actual training data and the synthetic data generated by the generator to discriminate whether the input data is actual data or synthetic data. In this case, the generator and discriminator trained adversarially, so that the synthetic data generated by the generator is trained to generate images similar to real ones.

The training is performed by allowing the generator to generate the synthetic TEC map from the random vector, and the discriminator to discriminate between the synthetic TEC map generated by the generator and the actual TEC map image data (the TEC map image data according to IRI-2016) while reducing the loss between the two images. As the number of epoch increases, the loss decreases, and the generator generates the synthetic TEC map that is very similar to the actual TEC map image data.

In the measurement input step (S40), the measurement input unit 40 receives the observed TEC map image data corresponding to the TEC map image data generated by the ground truth input step (S20) through the linked external model. Here, the “outside” refers to a connected external computational unit, and the observed TEC map image data refers to TEC map image data estimated using GNSS data. As illustrated in FIG. 4, the TEC map image data estimated using the GNSS data is missing data in areas with geographical limitations of GNSS observatories, such as the ocean.

In the optimization processing step (S50), the optimization processing unit 50 optimizes the neural network generated by the generation step (S10) using the pre-stored optimization algorithm so that the difference between the synthetic TEC map generated by the generation step (S10) and the observed TEC map image data corresponding to the synthetic TEC map is minimized,

Specifically, the synthetic TEC map generated by the generation step (S10) may be generated by receiving the random vector for the latent space and arbitrary TEC map condition information, as described above, and the TEC map image data generated using the TEC map condition information may be received by the ground truth input step (S20). In addition, in the measurement input step (S40), the observed TEC map image data corresponding to the TEC map image data generated by the ground truth input step (S30), in other words, the observed TEC map image data corresponding to the empirical data for generating the TEC map image data by the ground truth input step (S30) may be received.

In the optimization processing step (S50), it is preferable to perform the optimization of the neural network of the generator using the observed TEC map image data so that the difference between the synthetic TEC map generated by the generation step (S10) and the observed TEC map image data corresponding to the synthetic TEC map is minimized.

As described above, since the observed TEC map image data includes missing regions, in the optimization processing step (S50), the values of the measured portions in the observed TEC map image data may be compared with the corresponding portions in the output values of the synthetic TEC map to perform the optimization for the regions that do not exist in the observed TEC map image data but exist in the synthetic TEC map. Of course, the optimization is also performed to minimize differences between existing regions.

The present disclosure is not limited to the optimization algorithm itself for neural network optimization.

In this way, in the first model processing step (S200), the optimized neural network of the generator is stored as the first artificial intelligence model, and thus, even when the observed TEC map image data including the missing regions is input, the complete synthetic TEC map without the missing regions reconstructing the observed TEC map image data is output.

In the synthesis processing step (S300), the synthesis processing unit 300 preferably synthesizes the observed TEC map image data received by the data input step (S100) and the synthetic TEC map reconstructed by the first model processing step (S200) using the pre-stored image processing algorithm, thereby generating the optimized TEC map image data.

That is, as illustrated in FIG. 4, in the synthesis processing step (S300), the observed TEC map image data received by the data input step (S100) and the synthetic TEC map reconstructed by the first model processing step (S200), which are two different image data, are naturally synthesized using the Poisson Blending technique as the pre-stored image processing algorithm, thereby generating the optimized TEC map image data. In this way, the observed ionospheric structure is preserved, and the missing area is filled in with the synthetic TEC map, thereby generating the optimized TEC map image data, as illustrated in FIG. 3.

When simply synthesizing the observed TEC map image data and the synthetic TEC map, there is a problem in that the image itself becomes significantly distorted because pixels corresponding to the missing region of the observed TEC map image data in the synthetic TEC map are mismatched compared to the surrounding pixels. Therefore, in the synthesis processing step (S300), the gradient value between the observed TEC map image data received by the data input step (S100) and the synthetic TEC map reconstructed by the first model processing step (S200) is minimized so that the observed TEC map image data is naturally synchronized with the surrounding pixels, thereby generating the optimized TEC map image data.

In addition, the optimized TEC map image data generated by the synthesis processing step (S300) not only simply compensates for the loss of the observed TEC map image data, but may also accurately reconstruct small-scale structures.

In particular, global TEC maps tend to be easier to learn with deep learning techniques due to their large-scale structural features. However, although local TEC maps include various small-scale structures, the learning process may be more difficult. However, by providing the optimized TEC map image data that accurately reconstructs even small-scale transformations through the first model processing unit 200 and the synthesis processing unit 300, more precise TEC map image data is provided.

FIG. 5 is a diagram illustrating the observed TEC map image data, the TEC map image data generated by the empirical model, and the optimized TEC map image data generated by the synthesis processing step (S300). It may be confirmed that the optimized TEC map image data generated by the synthesis processing step (S300) preserves the ionospheric structure observed in the observed TEC map image data, while the missing regions are filled with the synthetic TEC map.

The present disclosure goes beyond the reconstruction of the complete TEC map image data and aims to predict the TEC map image data in the future using the reconstructed TEC map image data.

To this end, in the second model processing step (S400), the second model processing unit 400 inputs the optimized TEC map image data generated by the synthesis processing step (S300) to the stored second artificial intelligence model, thereby outputting the predicted TEC map image data at predetermined time intervals from the point in time at which the observed TEC map image data was input until a predetermined point in time later.

Here, the predetermined point in time means 24 hours, and the predetermined time means 1 hour. The predicted TEC map image data at 1-hour intervals from the point in time of the observed TEC map image data input through the data input step (S100) until 24 hours later is output. In this case, the predetermined point in time and the predetermined time are not necessarily limited to these. However, although the predetermined point in time and the predetermined time are not necessarily limited to these values, various experimental results of the present disclosure have confirmed that, when limited to 24 hours and 1 hour, the prediction results exhibit the highest reliability and accuracy, and thus these values were adopted.

As illustrated in FIG. 7, prior to performing the second model processing step (S400), the TEC map prediction method using deep learning according to an embodiment of the present disclosure stores a data collection step (S60), a set generation step (S70), and a learning processing step (S80), thereby storing the second artificial intelligence model.

In the data collection step (S60), the data collection unit 60 inputs the observed TEC map image dataset at predetermined time intervals for a predetermined period of time to the neural network optimized by the optimization processing step (S50), and receives the synthetic TEC map.

As described above, since the best prediction result is output when the predetermined point in time is 24 hours and the predetermined time is 1 hour, in the data collection step (S60), the observed TEC map image data at 1-hour intervals up to 24 hours prior to a certain point in time or the observed TEC map image data at 1-hour intervals up to 24 hours immediately following a certain point in time are received, and the synthetic TEC map corresponding to each observed TEC map image data are output, thereby generating the synthetic TEC map.

In the set generation step (S70), the set generation unit 70 synthesizes each synthetic TEC map received by the data collection step (S60) and the corresponding observed TEC map image data using the pre-stored image processing algorithm, thereby generating the optimized TEC map image dataset.

Specifically, in the set generation step (S70), the Poisson Blending technique is used as the pre-stored image processing algorithm to naturally synthesize the observed TEC map image data received by the data collection step (S60) and the reconstructed synthetic TEC map, which are two different image data, thereby generating the optimized TEC map image data.

In the learning processing step (S80), the learning processing unit 80 performs the learning process using the optimized TEC map image dataset by the set generation step (S70) based on the convolutional long short-term memory (ConvLSTM) model.

The ConvLSTM model, which is a variant of the LSTM network, integrates convolution operations into the standard LSTM architecture. By combining the memory preservation function of LSTM with the spatial pattern recognition function of the convolutional neural network, it effectively processes sequential data with spatial and temporal structures.

In the present disclosure, for predicting the TEC map image data, the input data is the optimized TEC map image data, which is synthetic TEC map, rather than the observed TEC map image data. As described above, the observed TEC map image data may include the missing regions due to various factors.

Since these missing regions ultimately cause significant problems during the training process of the deep learning model, the present disclosure goes beyond simple data supplementation and provides high-quality data that reflects the characteristics and patterns of the observed data as the training data, thereby ensuring a complete dataset essential for training a deep learning predictive model.

In other words, the complete dataset generated using the optimized TEC map image data allows the predictive model to learn consistent patterns, resulting in a stable training process and ultimately better performance. In particular, models such as ConvLSTM may offer significant advantages in learning spatial and temporal patterns, resulting in improved predictive performance.

The learning processing unit 80 utilizes the ConvLSTM model instead of the LSTM model. From various experimental results, it was found that the prediction results of the LSTM model exhibited discontinuities in the TEC values across different grids, whereas the prediction results of the ConvLSTM model showed continuity in the TEC values even across different grids, demonstrating superior performance.

FIG. 6 illustrates the results of calculating an RMSE value between the observed TEC map image data and the predicted TEC map image data corresponding thereto to quantify model-specific performance based on various experimental results according to the present disclosure.

The RMSE value for each grid was calculated and displayed at each prediction time (1 hour) from the reference time. As a result, it may be seen that, on average, the 1×1 LSTM model has the highest RMSE value and the ConvLSTM model has the lowest RMSE value.

In the second model processing step (S400), it is preferable that the model generated by the learning processing step (S80) is stored as the second artificial intelligence model.

Through this, in the second model processing step (S400), the predicted TEC map image data at 1-hour intervals for up to 24 hours based on the input TEC map image data, or simply 24 predicted TEC map image data is output.

Meanwhile, the TEC map prediction system and method using deep learning according to an embodiment of the present disclosure may be implemented in the form of program instructions that can be executed through various means for electronically processing information and may be recorded on a storage medium. The storage medium may include program commands, data files, data structures, or the like, alone or a combination thereof.

The program commands recorded in the storage medium may be especially designed and constituted for the present disclosure or be known to those skilled in a software field. Examples of the storage medium may include a magnetic medium such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a random access memory (RAM), a flash memory, or the like. Examples of the program commands include a high-level language code capable of being executed by an apparatus electronically processing information using an interpreter, or the like, for example, a computer, as well as a machine language code made by a compiler.

According to the present disclosure, the TEC map prediction system and method using deep learning may utilize deep convolutional generative adversarial network-Poisson blending (DCGAN-PB), thereby restoring the missing regions of the observed TEC map to generate the complete optimized TEC map image data.

Furthermore, it is possible to predict and provide the variation in the TEC map image data for up to 24 hours in the future based on the optimized TEC map image data generated by using the Convolutional Long-Short Term Memory (ConvLSTM) technique.

Hereinabove, although the present disclosure has been described by specific matters such as detailed components, exemplary embodiments, and the accompanying drawings, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to these exemplary embodiments, but the claims and all of modifications equal or equivalent to the claims are intended to fall within the scope and spirit of the present disclosure.

What is claimed is:

1. A total electron content (TEC) map prediction system using deep learning, comprising:
a data input unit that receives externally observed TEC map image data;
a first model processing unit that inputs the observed TEC map image data to a stored first artificial intelligence model and receives reconstructed synthetic TEC map;
a synthesis processing unit that synthesizes the observed TEC map image data received and the reconstructed synthetic TEC map using a pre-stored image processing algorithm to generate optimized TEC map image data; and
a second model processing unit that inputs the optimized TEC map image data to a stored second artificial intelligence model and receives predicted TEC map image data at predetermined time intervals from a predetermined point in time based on when the optimized TEC map image data is input.

2. The TEC map prediction system using deep learning of claim 1, further comprising:
a generation unit that is implemented as s a convolutional neural network, and receives a random vector for a latent space and arbitrary TEC map condition information to generate corresponding synthetic TEC map;
a ground truth input unit that receives TEC map image data generated using the TEC map condition information through a linked empirical model;
a discrimination unit that is implemented as a convolutional neural network, and receives the TEC map image data generated by the ground truth input unit and the synthetic TEC map generated by the generation unit to discriminate whether the input data is the received TEC map image data or the generated TEC map image data;
a measurement input unit that receives the observed TEC map image data corresponding to the TEC map image data generated by the ground truth input unit from the outside; and
an optimization processing unit that optimizes the neural network of the generation unit using the pre-stored optimization algorithm so that a difference between the synthetic TEC map generated by the generation unit and the observed TEC map image data corresponding to the synthetic TEC map is minimized,
wherein the generation unit and the discrimination unit are trained based on a deep convolution generative adversarial network, and
the neural network of the generation unit optimized by the optimization processing unit is stored as the first artificial intelligence model.

3. The TEC map prediction system using deep learning of claim 2, further comprising:
a data collection unit that inputs an observed TEC map image dataset at predetermined time intervals for predetermined time to the neural network of the generation unit optimized by the optimization processing unit, and receives a synthetic TEC map;
a set generation unit that synthesizes each synthetic TEC map and the corresponding observed TEC map image data using the pre-stored image processing algorithm to generate an optimized TEC map image dataset; and
a learning processing unit that performs learning process using the optimized TEC map image dataset based on a convolutional long short-term memory model,
wherein the model generated by the learning processing unit is stored as the second artificial intelligence model.

4. A TEC map prediction method using deep learning by a TEC map prediction system using deep learning in which each step is performed by a computational processing unit, the TEC map prediction method using deep learning comprising:
a data input step of receiving, by a data input unit, externally observed TEC map image data;
a first model processing step of inputting, by a first model processing unit, the observed TEC map image data received in the data input step to a stored first artificial intelligence model, and receiving reconstructed synthetic TEC map;
a synthesis processing step of using, by a synthesis processing unit, a pre-stored image processing algorithm to synthesize the observed TEC map image data received in the data input step and synthetic TEC map reconstructed in the first model processing step and generate optimized TEC map image data; and
a second model processing step of inputting, by a second model processing unit, the optimized TEC map image data to a stored second artificial intelligence model in the synthesis processing step and receiving predicted TEC map image data at predetermined time intervals from a predetermined point in time based on when the optimized TEC map image data is input.

5. The TEC map prediction method using deep learning of claim 4, further comprising:
prior to performing the first model processing step,
a generation step of receiving, by a generation unit implemented as a convolutional neural network, a random vector for a latent space and arbitrary TEC map condition information to generate the corresponding synthetic TEC map;
a ground truth input step of receiving, by a ground truth input unit, TEC map image data generated using the TEC map condition information through a linked empirical model;
a discrimination step of receiving, by a discrimination unit implemented as the convolutional neural network, the TEC map image data generated by the ground truth input step and the synthetic TEC map generated by the generation step to discriminate whether the input data is the received TEC map image data or the generated TEC map image data;
a measurement input step of receiving, by a measurement input unit, the observed TEC map image data corresponding to the TEC map image data generated by the ground truth input step from the outside; and
an optimization processing step of optimizing, by an optimization processing unit, the neural network generated by the generation step using a pre-stored optimization algorithm so that a difference between the synthetic TEC map generated by the generation step and the observed TEC map image data corresponding to the synthetic TEC map is minimized,
wherein the generation step and the discrimination step are trained based on a deep convolution generative adversarial network, and
the neural network optimized by the optimization processing step is stored as the first artificial intelligence model.

6. The TEC map prediction method using deep learning of claim 5, further comprising:
prior to performing the second model processing step,
a data collection step of inputting, by a data collection unit, an observed TEC map image dataset at predetermined time intervals for a predetermined time to the neural network optimized by the optimization processing step, and receiving a synthetic TEC map;
a set generation step of synthesizing, by a set generation unit, each synthetic TEC map received by the data collection step and the corresponding observed TEC map image data using the pre-stored image processing algorithm to generate an optimized TEC map image dataset; and
a learning processing step of performing, by a learning processing unit, learning process using the optimized TEC map image dataset by the set generation step based on a convolutional long short-term memory model,
wherein the model generated by the learning processing step is stored as the second artificial intelligence model.
